(19) United States
(12) Patent Application Publication
(10) Pub. No.: US 2003/0039039 A1
(43) Pub. Date: Feb. 27, 2003

(54) Vehicle driver's-side, rear-view mirror, eliminating blind spot

(76) Inventors: Chester L. Thomas, Logan, IL (US); Garry G. Thomas, Logan, IL (US)

Correspondence Address: Richard C. Litman, LITMAN LAW OFFICES, LTD., P.O. Box 15035, Arlington, VA, 22215, US

(21) Appl. No.: 09/933,149

(22) Filed: Aug. 21, 2001

(51) Int. Cl. G02B 5/08; G02B 7/18; G02B 7/182; G02B 5/10

(52) U.S. Cl. 359/865; 359/843; 359/866; 359/868

(57) ABSTRACT

A vehicle driver's-side, rear-view mirror eliminating the blind spot. The rear-view mirror comprises a two-piece mirror structure having a planar mirror portion and a separate and distinct, curved mirror portion, outboard of the planar mirror portion, wherein the curved mirror portion curves at a constant radius away from the planar mirror portion horizontally. The rearview mirror thus has a wide angle viewing area permitting the vehicle operator to see clearly in the “blind spot.” A mounting block with adhesive, and mounted on and behind the mirror allows the mirror to be mounted directly on the mirror surface of a conventional vehicle driver's-side mirror assembly. Or, the block may include standard mounting bolts, adhesive, etc., for mounting the mirror within the frame of a standard outboard mirror assembly. Thus, the mirror assembly may be an after-market item, or an original equipment manufacture item.

### BACKGROUND OF THE INVENTION

1. Field of the Invention

The present invention relates generally to vehicle rear view mirrors and, more specifically, to a vehicle, driver's-side rearview mirror with an inboard planar mirror portion and an outboard radiused portion, which eliminates the blind spot.

2. Description of the Related Art

Standard vehicle side-mounted, rear-view mirrors have a major deficiency. The typical planar side-view mirror is adjusted by the driver of the vehicle so that the reflection of other vehicles in the adjacent lane can be seen unless, however, another vehicle is directly beside the vehicle. The driver's view of a vehicle directly adjacent to his vehicle is hampered because the other vehicle is in the “blind spot” where the driver is simply unable to see the other vehicle's reflection. An uncountable number of wrecks have occurred as a result of the blind spot when a driver does not see another vehicle and moves into the adjacent lane.

The related art discloses numerous automobile side-mounted, rear-view mirrors that are designed to eliminate the blind spot and consequently fully cover the entire side and rear of the automobile. These teachings run the gamut of dual reflective surface rear view mirrors, some with two planar mirrors, some with one planar and one convex mirror, and even others with one planar mirror and one radiused mirror. However, these patents fail to teach or disclose a mirror assembly that successfully eliminates the blind spot.

U.S. Pat. No. 4,331,382 issued May 25, 1982 to Henry W. Graff teaches an after market mirror with a planar section and an outboard radiused section. The mirror has a rear adhesive spacer for attaching the same to a conventional driver's side rear view mirror. The Graff mirror presents two distinct problems when compared with the instant invention. First, the Graff mirror structure is one piece, with no clear line of separation between the planar and radiused sections. This feature is particularly uncomfortable to the user, we have found. Also, the cost of producing and stocking a mirror can be prohibitive. Second, The radiused section has a radius of 8 inches, preferably, with a range of possibilities between 7 and 9 inches. We have found that range to be unacceptable and our radiused section has a radius on the order of about 5 inches; this assures a complete view of the blind spot.

U.S. Pat. No. 4,245,894 issued Jan. 20, 1981 to Curt Luchtenberg discloses a rearview mirror containing two mirror sections that are angled with respect to each other and are contiguous to each other along a kink line. In one embodiment, both of the mirrors may have a radius of curvature of about 80 inches or so. The line of separation or kink line between the two mirror sections is designed to alert the driver exactly where the mirror changes from one to the other. There is no opaque strip between the two sections, nor is one planar and the curved as in the instant invention. Mirrors similar to Luchtenburg's are seen in U.S. Pat. No. 3,628,851 issued to Harry J. Robertson, and U.K/Patent Application No. 2 151 568A published Jul. 24, 1985.

U.S. Pat. No. 4,859,046 issued to Traynor et al. on Aug. 22, 1989 shows a rearview mirror having two planar mirror sections, divided by an opaque strip at least 1/4 inch wide. The strip is double the width of that of the instant invention, and there is no radiused mirror section either in the Traynor patent. A teaching similar to Traynor is found in U.S. Pat. No. 5,153,781, issued Oct. 6, 1992 to Dale E. Brandt.

Disclosures of driver's-side mounted rear-view mirrors having an inboard planar section and outboard convex section are found in U.S. Pat. Nos. 3,389,952 issued Jun. 25, 1968 to John J. Tobin, Jr., and U.S. Pat. No. 5,005,962 issued Apr. 9, 1991 to Karl W. Edelman. In Tobin, a strip of undefined width divides the convex and planar mirror sections. The problem with both of these teachings is the provision of a convex section, which distorts everything in both horizontal and vertical directions. In direct contradistinction thereto, the instant invention with a radiused outboard mirror section distorts things seen only in a horizontal direction, making our invention much easier on the eyes, and thus more reliable and safer in use.

U.S. Pat. No. 5,579,133 issued to Black et al. on Nov. 26, 1996 shows an attachment for an existing rearview mirror apparatus of an automobile. The invention of Black is a one-piece mirror that includes a flat portion and an angled portion separated by a concave radius area of demarcation. The two mirror sections are planar and positioned oppositely of our invention, with the smaller section inboard and angled outwardly. There is no clear line of separation between the two sections, a feature that we have found particularly annoying and uncomfortable to the eye in transiting a view from one mirror section to the other. The mirror of the Black patent may be an after market or original equipment item. Double sided adhesive tape secures the after market mirror in place in Black. Again, no radiused mirror section is taught and there is no clear separation line between the two mirror sections, as in our invention.

The above discussion fairly describes the relevant art, it being recognized that there are literally hundreds of additional disclosures, teachings and patents in the area of driver's side mounted, rear-view mirrors which attempt to eliminate the blind spot. However, none are directed to the rather precise solution we have found, as will become readily apparent below.

None of the above inventions and patents, taken either singularly or in combination, is seen to describe the instant invention as claimed. Thus, an vehicle, driver's side mounted, rear-view mirror that effectively eliminates the blind spot is desired.

### SUMMARY OF THE INVENTION

The invention is a vehicle driver's-side, rear-view mirror eliminating the blind spot. The rear-view mirror comprises a two-piece mirror structure, with a planar mirror portion and a separate and distinct, curved mirror portion, outboard of the planar mirror portion. The curved mirror portion curves at a constant radius away from the planar mirror portion, in the sense of a horizontal plane. The rear-view mirror thus has a wide angle viewing area permitting the vehicle operator to see clearly in the “blind spot.”

A mounting block with adhesive, and mounted on and behind the mirror allows the mirror to be mounted directly on the mirror surface of a conventional vehicle driver's-side mirror assembly. On the other hand, the block may include standard mounting bolts, adhesive, etc., for mounting the mirror within the frame of a standard outboard mirror assembly. Thus, the mirror assembly may be an after-market item, or an original equipment manufacture item. The radius of curvature of the outboard, radiused mirror portion is on the order of five inches. There is also a distinct opaque line of separation between the two mirror portions so that one's eyes travel comfortably between the two portions. The outboard portion is radiused and not made as a convex surface, so that distortion is horizontal only, and not vertical. The invention may be manufactured in a wide range of sizes and shapes so as to be accommodated in and/or on most any conceivable outside mirror frame structure.

Accordingly, it is a principal object of the invention to provide a two-part, driver's side mounted rear-view mirror that eliminates the blind spot, comfortably to the viewer, and with minimum distortion of the rear view.

It is another object of the invention to provide a two part rear view mirror that comfortably removes the blind spot, and which may be mounted directly on the mirror already in place on the vehicle, or may be a part of original equipment manufacture (OEM).

It is a further object of the invention to provide a two part rear view mirror that comfortably eliminates the blind spot, and may be dimensioned and configured in a wide range of overall sizes, in order to fit virtually any size and shape of outside, conventional rear view mirror frame.

Still another object of the invention is to develop a mirror that does not require undue length or size greater than a standard automobile's side-view mirror.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a vehicle driver's side, compound, rear-view mirror according to the present invention.

FIG. 2 is a front elevational view of the invention as seen in FIG. 1, and drawn to an enlarged scale.

FIG. 3 is a rear elevational view of the invention as seen in FIG. 2.

FIG. 4 is a top view of the invention as seen in FIG. 3.

FIG. 5 is an exploded, perspective view showing the invention as it may be mounted onto a mirror in a conventional, outside rearview mirror frame.

FIG. 6 is a perspective view similar to FIG. 5 but showing parts in assembly.

Similar reference characters denote corresponding features consistently throughout the attached drawings.

### DETAILED DESCRIPTION OF THE PREFERRED EMBODIMENTS

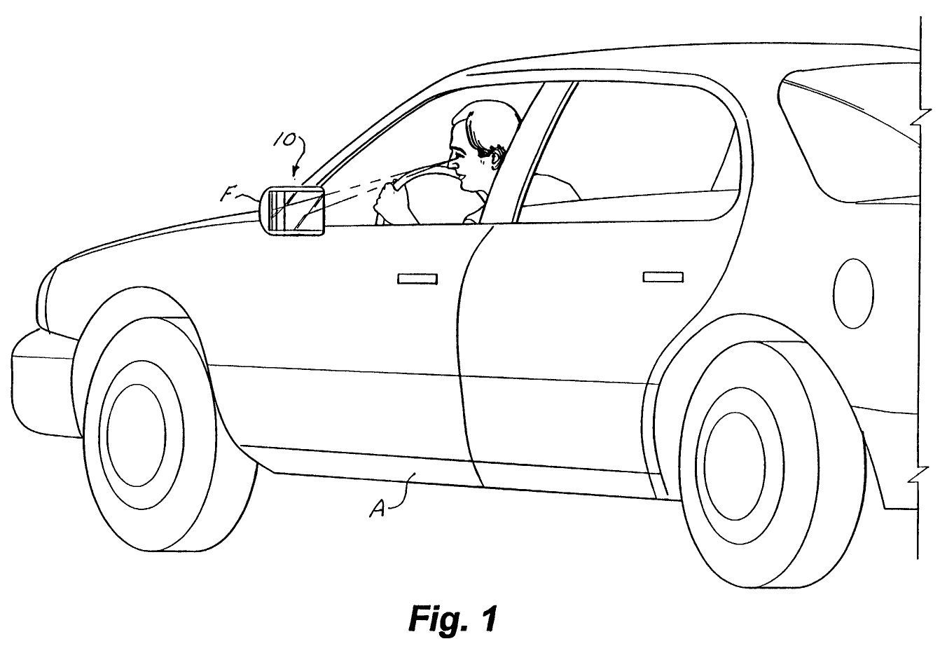

The present invention comprises a rear-view mirror as indicated by the reference numeral 10 in FIG. 1, mounted in the driver's-side, rear-view mirror frame F of an automobile A. While various rear-view mirrors purporting to eliminate the blind spot have been developed in the past, the present side-view mirror 10 incorporates a wide angle mirror apparatus which allows the operator of the motor vehicle a far greater field of vision than conventional mirrors. Also, the present invention is useful with any type of vehicle, from automobile to tractor trailer, and scooter to motorcycle. The term vehicle, as used herein, is meant to cover any type of means of conveyance or transport.

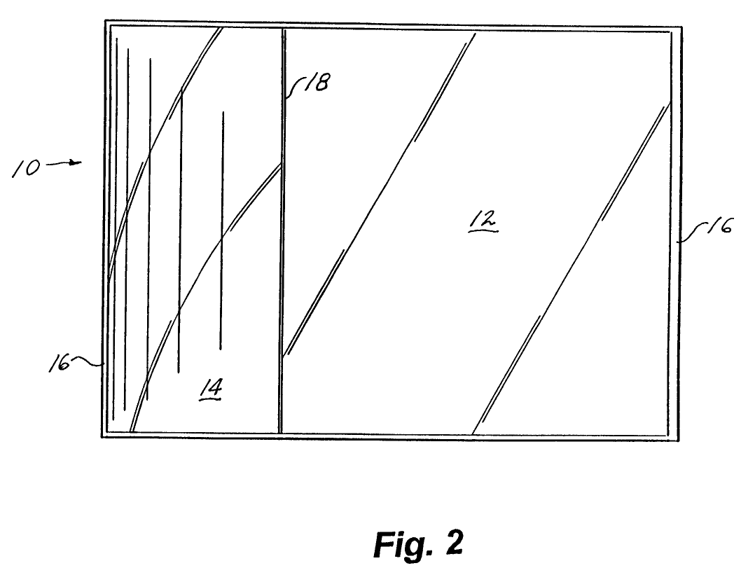

As illustrated in FIG. 2, the rear-view mirror 10 includes al flat, planar inboard section or portion 12, a separate, radiused, outboard portion 14, and a mounting frame 16 for the mirror portions. Also, and importantly, there is an opaque dividing strip 18 between the two portions 12, 14, which in a preferred embodiment of the invention is about 1/4 inch wide. We have found that this division of sections makes use of the mirror 10 much easier on the eyes, and a division strip 1/4 inch wide provides a distinct but comfortable to view separation area or line between the two sections.

With respect to the radius of the curved portion 14, we have found that it should be on the order of about 5 inches. Anything shorter tends to distort the rear view horizontally to a degree that discerning objects may become difficult or even impossible. On the other hand, a larger radius would reduce distortion, but not effectively eliminate the blind spot which, of course, is the principal reason for this invention in the first place. The adequate compromise is a radius of right about five inches.

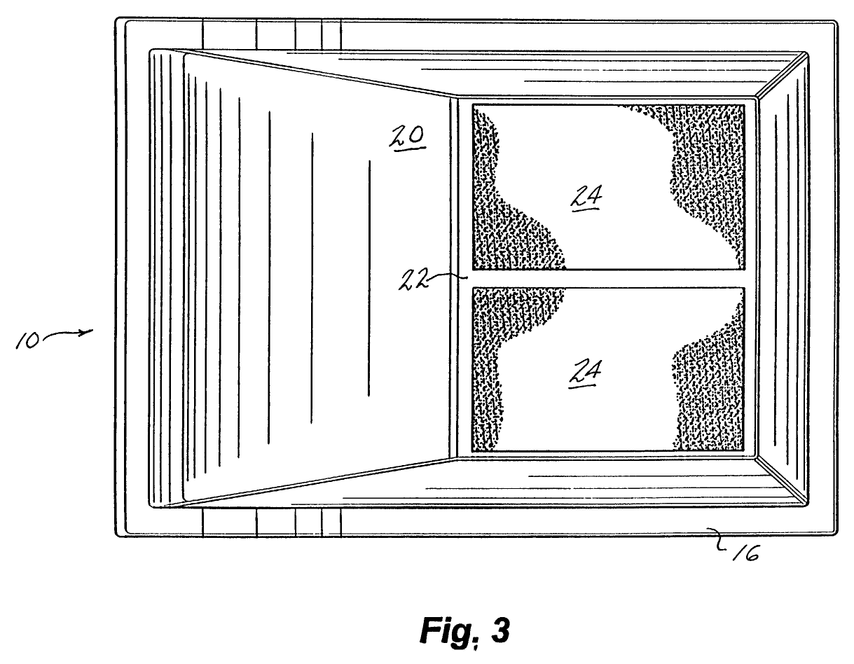

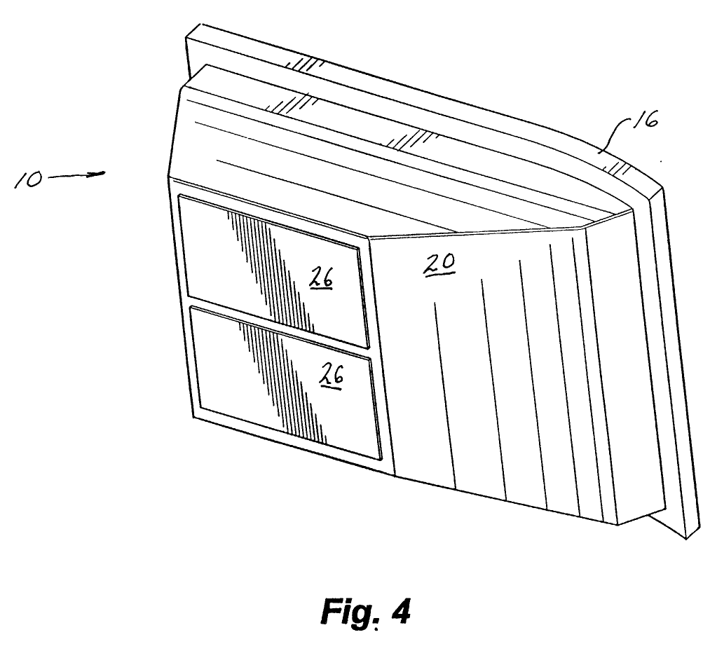

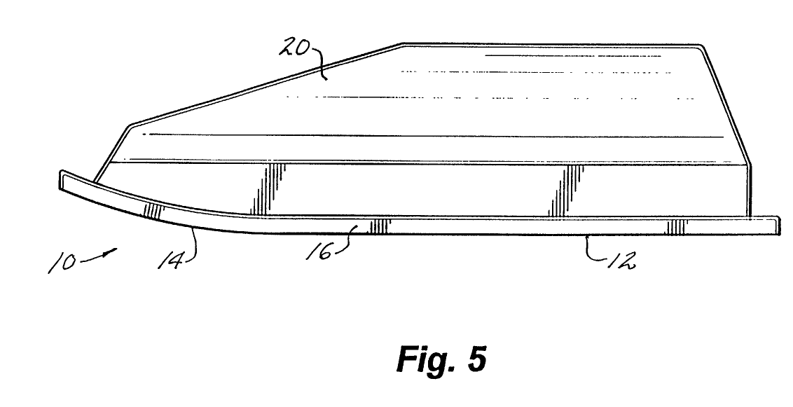

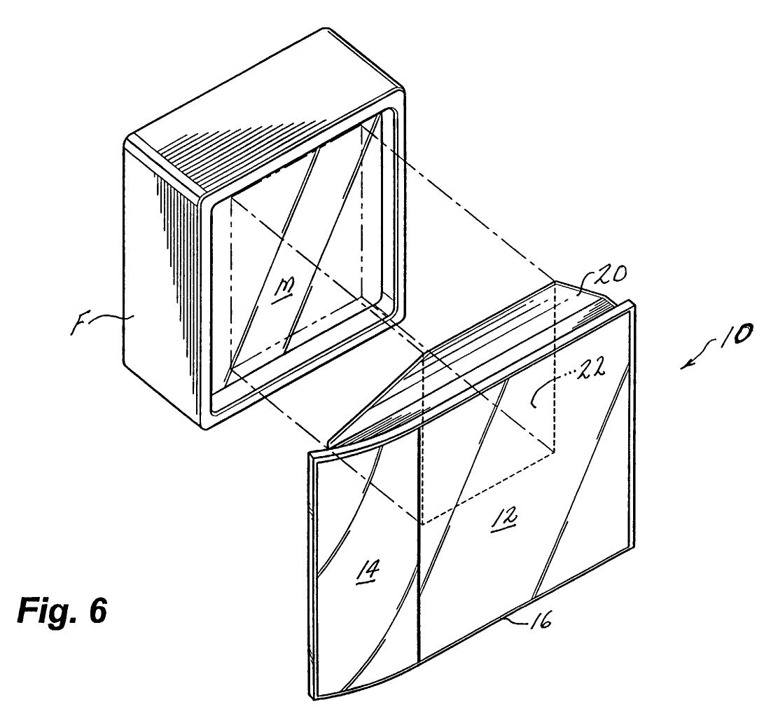

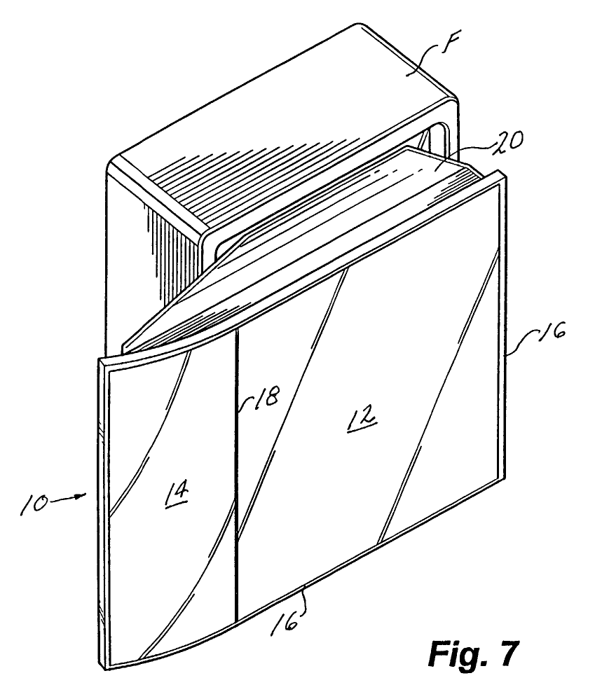

Referring now to FIGS. 3 and 4, the rest of the structure of the invention becomes apparent. The frame 16 includes a mounting block 20 dimensioned and configured to include a rear mounting face 22, with self-adhesive 24 covered by release liners 26 prior to use. This is for attachment of the invention 10 to a conventional mirror within its frame. Such after market assembly is diagrammatically illustrated in FIG. 6. A conventional mirror M and frame F are shown, with the rear mounting face 22 lined up centrally with respect to mirror M. The release liners 26 are removed and the mirror 10 is mounted. The result is seen in FIG. 7, with the radiused mirror portion 14 outboard of the frame F. This provides an easily mounted mirror 10 with a radiused portion 14 extended outwardly somewhat. It is important to note here that the block 20 is streamlined in configuration to as to minimize wind resistance. Also, the mounting face 22 is deep within the mirror frame so as not to become readily in contact with the elements or, which could be more damaging, water and spray under pressure in a car wash.

As noted earlier, the mirror 10 could be an OEM item, with block face 22 being mounted within frame F means known in the industry, e.g., screws and bolts, glues, etc. In this case, of course, the mirror M would be eliminated. In either event, An effective and attractive mirror 10 is provided. Also, it should be noted that the shapes shown in the drawings are illustrative only. The invention may be made in a wide variety of shapes and sizes to accommodate any sort of standard mirror frame. On the other hand, a special mirror frame can be provided with the invention to accommodate the size and shape seen in the drawings. In the specific drawings herein, the mirrors would each be four inches high. Mirror 12 is also four inches wide, and the radiused mirror 14 is about one and five eighths inches wide.

It is to be understood that the present invention is not limited to the embodiments described above, but encompasses any and all embodiments within the scope of the following claims.

We claim:

1. A vehicle driver's side, rear-view mirror assembly which eliminates the blind spot, comprising:
a two-part mirror assembly having;
a planar mirror portion; and
an outboard, radiused mirror portion;
wherein said outboard mirror portion curves away from said planar mirror portion in a horizontal plane;
there being an opaque, vertical line of separation between said planar and radiused mirror portions; and
the radius of curvature of said radiused mirror portion being on the order of about five inches.

2. A vehicle driver's side, rear-view mirror assembly which eliminates the blind spot as in claim 1, wherein said outboard mirror portion curves at a constant radius, in a horizontal plane, away from said planar mirror portion.

3. A vehicle driver's side, rear-view mirror assembly which eliminates the blind spot as in claim 1, wherein said planar mirror portion has a horizontal dimension on the order of about 4 inches, and said radiused, outboard mirror portion has a horizontal dimension of about one and five-eighths inches.

4. A vehicle driver's side, rear-view mirror assembly which eliminates the blind spot as in claim 1, wherein said opaque, vertical line of separation is about one-eighth of an inch wide.

5. A vehicle driver's side, rear-view mirror assembly which eliminates the blind spot as in claim 1, further comprising:
a mounting block behind at least said planar mirror portion, said block having a rear surface;
self-adhesive means on said rear surface; and
release liner means covering said self-adhesive means;
whereby upon removal of said release liner means, said block may be affixed to a planar surface.

6. A vehicle driver's side, rear-view mirror assembly which eliminates the blind spot as in claim 5, wherein said outboard mirror portion curves at a constant radius, in a horizontal plane, away from said planar mirror portion.

7. A vehicle driver's side, rear-view mirror assembly which eliminates the blind spot as in claim 5, wherein said planar mirror portion has a horizontal dimension on the order of about 4 inches, and said radiused, outboard mirror portion has a horizontal dimension of about one and five-eighths inches.

8. A vehicle driver's side, rear-view mirror assembly which eliminates the blind spot as in claim 5, wherein said opaque, vertical line of separation is about one-eighth of an inch wide.

9. A vehicle driver's side, rear-view mirror assembly which eliminates the blind spot as in claim 1, further comprising:
a mounting block behind at least said planar mirror portion, said block having a rear surface;
mounting means on said rear surface, for mounting said block within the frame of a vehicle driver's-side rear-view mirror frame.

10. A vehicle driver's side, rear-view mirror assembly which eliminates the blind spot as in claim 9, wherein said outboard mirror portion curves at a constant radius, in a horizontal plane, away from said planar mirror portion.

11. A vehicle driver's side, rear-view mirror assembly which eliminates the blind spot as in claim 9, wherein said planar mirror portion has a horizontal dimension on the order of about 4 inches, and said radiused, outboard mirror portion has a horizontal dimension of about one and five-eighths inches.

12. A vehicle driver's side, rear-view mirror assembly which eliminates the blind spot as in claim 9, wherein said opaque, vertical line of separation is about one-eighth of an inch wide.
